(19) United States
(12) Patent Application Publication
(10) Pub. No.: US 2024/0020648 A1
(43) Pub. Date: Jan. 18, 2024

(54) BENEFIT ADMINISTRATION PLATFORM

(71) Applicant: Steady Platform LLC, Atlanta, GA (US)

(72) Inventors: Jason Robinson, Atlanta, GA (US); Adam Roseman, Atlanta, GA (US)

(21) Appl. No.: 17/864,589

(22) Filed: Jul. 14, 2022

(51) Int. Cl. G06Q 10/10; H04L 9/00

(52) U.S. Cl. CPC G06Q 10/1057; H04L 9/50

(57) ABSTRACT

Provided are systems and methods for verification and management of benefit administration. The system can determine the eligibility of users to receive basic income and other forms of benefits, grants, aid, etc. Furthermore, the system can automate and manage the distribution of such benefits while creating an immutable/auditable trail of the disbursements. Accordingly, the verification system described herein can prevent fraud and other forms of malfeasance within the benefit administration process.

### BACKGROUND

Employment opportunities and career roles are increasingly becoming automated. As a result, many job opportunities and professions have ceased to exist or have been otherwise rendered financially obsolete. In some cases, the automation is the result of efficiency, robotics, AI, or other substitutes for human intelligence and labor. The result is an increasing risk of unemployment, which can eventually result in widespread personal financial difficulties for many families. In aggregate, these personal financial crises can cover industries, regions, or nations. Many organizations and agencies, such as local and federal governments, private organizations, charities, and the like, provide benefits and grants to persons creating a social safety net. The benefits can include funds in the form of basic income, guaranteed income, cash benefits, and the like. However, the administration of these programs and processes can be challenging in many ways.

As just one example, a recent fraud scheme involved a ring of co-conspirators stealing approximately $2,000,000 in unemployment benefits from the State of California. In that scheme, the co-conspirators would acquire personally identifiable information (PII) such as names, dates of birth, and social security numbers of individuals who were not eligible for unemployment benefits, including pandemic benefits, because they were employed, retired, or incarcerated. The co-conspirators then allegedly used the information to make fraudulent online applications for benefits from the California Employment Development Department (EDD). Once the applications were approved, members of the conspiracy received EDD-funded debit cards that allowed them to withdraw money from automated teller machines across Southern California.

This incident is just one example of many. For organizations such as governmental, business, academic, or otherwise, which distribute benefits, payments, and the like, some of the biggest obstacles are verifying eligibility of the persons involved, including whether they have told the truth on their registration forms, distributing payments in a way that can subsequently be guaranteed, confirming receipt, recording results, and auditing results.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIGS. 1A-1C are diagrams illustrating a host platform that is configured for benefit-related verification and administration in accordance with example embodiments.

FIGS. 2A-2C are diagrams illustrating a process for automated distribution of benefits via a host platform in accordance with example embodiments.

FIG. 3A is a diagram illustrating a data ingestion process of a host platform in accordance with example embodiments.

FIGS. 3B-3D are diagrams illustrating a process of verifying a user based on personally-identifiable information (PII) in accordance with example embodiments.

FIGS. 4A-4C are diagrams illustrating a process of verifying income-based records in accordance with example embodiments.

FIGS. 5A-5C are diagrams illustrating a process of enhancing transaction records in accordance with example embodiments.

FIGS. 6A-6B are diagrams illustrating processes of reconciling transaction records in accordance with example embodiments.

FIG. 7A is a diagram illustrating a process of verifying eligibility of a user in accordance with an example embodiment.

FIG. 7B is a diagram illustrating a process of automatically disbursing future payments in accordance with an example embodiment.

FIG. 8 is a diagram illustrating a process of tracking progress of an eligibility verification process in accordance with an example embodiment.

FIG. 9 is a diagram illustrating a method of eligibility verification and automated benefit distribution in accordance with an example embodiment.

FIG. 10 is a diagram illustrating an example of a computing system for use in any of the examples described herein.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a reader with a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown, but is to be accorded the widest scope consistent with the principles and features disclosed herein.

As more jobs become automated and rendered obsolete, whether through advances in efficiency, robotics, AI, or other substitutes for human intelligence and labor, the risk of unemployment also increases. To mitigate such crises, organizations (e.g., government agencies, charities, NGOs, universities, etc.) overseeing large communities of people (e.g., town, city, state, country, region, jurisdiction, province, campus, etc.) provide people with financial aid in the form of funds and other benefits. However, ensuring that people are eligible (i.e., meet the requirements for the benefit as set forth by the organization or other governing body, etc.) and ensuring that payments are distributed successfully (and only repeated as intended, if repeat payments are indeed intended, including preventing duplicate payments) can be difficult. For example, fraud is becoming more prevalent, leading to payment of benefits to ineligible persons, overpayments of benefits to eligible persons, lack of payments to eligible persons, and the like. In many cases, the fraud is the result of identity theft.

The example embodiments are directed to a host platform that can verify the eligibility of persons for a benefit (e.g., unemployment benefits, social security benefits, disability benefits, basic income payments, grants, etc.). To do so, the host platform can verify the identity of a person, verify income of the person, verify any other payments received including from the same or similar benefit program, and the like. The platform may include multiple machine learning processes that can enhance data and make it more feasible to match and verify data records, such as payment transactions and data records with personally-identifiable information (PII) including first name, last name, social security number, address, email address, phone number, and the like. Furthermore, the host platform may also manage the disbursements of payments in a way that ensures only one payment is made to the eligible person per benefit period and that such payment is confirmed. The host platform may also create an auditable trail of the payments ensuring that others can subsequently audit the payments to ensure the person was paid properly.

In the example embodiments, a benefit may refer to funding such as basic income, or the like. Basic income is a stream of financial grants paid by governmental and/or non-governmental (e.g., social) organizations to residents and/or citizens of particular localities, regions, or nations, with the goal of wholly or partially satisfying the basic needs that those individual residents and/or citizens have. Distribution may or may not have a means test, and the amount of funds in a given disbursement may or may not depend on means, e.g., such that the amount of funds depends on the means that a person possesses. Additionally, basic income may include but is not limited to universal basic income (UBI), which is a benefit paid to all citizens of a given population, such as a town, city, state, country, etc. Cash benefits are benefits paid to individuals in fungible monetary units, typically on a fixed, periodically-recurring basis, with or without a defined end date. Guaranteed income is a stream of cash benefits payments made by governmental and/or non-governmental (e.g., social) organizations to help stabilize the financial lives of individuals and their families by providing an income floor that aims to address their basic needs.

When an organization, whether governmental, social, business, or otherwise, wants to distribute basic income, guaranteed income, or any other type of cash benefits program funds to individuals, several obstacles exist. Some of the obstacles include verifying whether a participant of a benefit program is eligible to receive such a benefit. In other words, does the person satisfy the criteria for the benefit, which may include restrictions on income, assets, property values, debts, and the like, based on the information provided and/or gathered?

In the example embodiments, the host platform may determine an individual's eligibility for grants and cash benefits, when they are initially applying for or being included in any relevant programs. Also, the host platform may recertify existing users upon request, at predetermined periodic intervals, upon checking whether particular conditions exist, and the like. In addition, the host platform may verify income and prevent fraud, when an eligibility test is performed. Furthermore, the host platform may verify the eligibility for basic income, guaranteed income, and/or any other cash benefits programs, or the like, including but not limited to demographic and residency requirements, as well as current period payment status (e.g., unpaid, pending, paid, hold, etc.). Furthermore, the host platform may verify each individual's eligibility for basic income grants, guaranteed income, and/or any other cash benefits programs, on an ongoing basis, as is appropriate for each particular program.

The host platform may also participate and manage the disbursement of funds/benefits as part of the benefit administration. For example, the host platform may include a scheduler that can schedule payments to a user at future times and trigger those payments at the future times. Furthermore, proof of such payments and proof of confirmation of such payments (e.g., by a financial institution or the person themselves) may be stored in an auditable and immutable trail on a blockchain ledger or other distributed environment. The host platform provides a mechanism for administering basic income, guaranteed income, and/or any other cash benefits programs to individuals in an automated and verifiable manner.

Some of the benefits of the verification platform described herein include the generality of solution, which enables multiple basic income cases to be addressed, including but not limited to partial basic income grants, full basic income grants, universal basic income (UBI) grants, guaranteed income grants, and any other cash benefits payments. The verification platform also provides an automated methodology for administering payments under the benefits program, which can lower administrative overhead, improve delivery reliability, and provide ongoing recertification and funds distribution, as needed. Furthermore, the host platform may serve as a certification authority capable of certifying income, identity, and the like. These verifications may be performed using various machine learning models, which can enhance the data that is ingested and add additional attributes to the data, which can be used to analyze and act based on the data.

In some embodiments, the verification platform may include or otherwise be embodied as a blockchain network of distributed computing machines/virtual machines, however, embodiments are not limited thereto. The blockchain network may be a public, permissioned, or private blockchain network. Examples of the types of blockchain frameworks that can be used include Ethereum, Solana, EOS, Cardano, Hyperledger Fabric, and the like. As an example, an application server may host a mobile application or web application that provides the verification processes described herein. The application server may be coupled to a blockchain network and may transmit results of the verification processes and confirmations of the payments to a blockchain ledger of the blockchain network. The blockchain network may include a plurality of blockchain-enabled peers (e.g., distributed computing machines, virtual machines, etc.) that work together to write to and/or manage the blockchain ledger.

Each of the blockchain-enabled peers may be a member of the blockchain network and may include a local copy of the blockchain ledger. Depending on the choice of blockchain protocol employed for the particular application, the peers may execute consensus-based protocols and network-wide communications including gossip to ensure that no single peer can update the blockchain ledger by themselves and also to ensure that a state of the content stored in the blockchain(s) on the local blockchain ledgers of all of the peers is the same/synchronized. Furthermore, to ensure that the blockchain ledger is “immutable” and thus cannot be changed, each new block added to the ledger may include a hash pointer to an immediately previous block on the blockchain ledger. For example, a committing peer may hash a value from the previous block (e.g., a block header, block data section, block metadata, or the like) and store the hash value in the new block (e.g., in a block header, etc.).

The blockchain-enabled peers may be trusting entities or untrusting entities with respect to each other. In some embodiments, the blockchain-enabled peers may work together to achieve a consensus (i.e., an agreement) on any data that is added to the blockchain ledger before it is committed. In some cases, peers may have different roles and peers may have multiple roles. As an example, a committing peer refers to a peer that stores a local copy of the blockchain ledger and commits blocks locally to its instance of the blockchain ledger. Most if not all peers in the blockchain network may be committing peers. Prior to the data being committed, peers execute a consensus process of some kind to ensure that the requirements for adding the data to the blockchain ledger (e.g., specified by policy of the blockchain, etc.) have been satisfied. Examples of consensus processes include proof of work, endorsement, proof of stake, proof of history, and the like.

An ordering service or ordering peer may receive transactions which are to be added to the blockchain and order the transactions based on priority (e.g., time of receipt, etc.) into a block. After the block is filled, the ordering service may generate a new block and distribute the block to the committing peers.

In some embodiments, blockchain transactions may require “endorsement” by at least a small subset of peers within the blockchain network before being added to a new block. In this example, an “endorsing” peer may receive a new blockchain transaction to be stored on the blockchain ledger, and perform an additional role of simulating content (e.g., within the blockchain transaction) based on existing content stored on the blockchain ledger to ensure that the blockchain transaction will not have issues or fail. The endorsement process may be performed prior to adding the blockchain transaction to the block by the ordering service. Thus, in that case, only “endorsed” transactions may be added to a new block to be committed to the blockchain ledger. In some embodiments, only a subset of peers (e.g., a small group of trusted systems out of a larger group of systems of the blockchain network, etc.) may endorse transactions.

Although the examples herein refer to a host platform that is integrated with a blockchain network/blockchain ledger for storage of data, the data may be stored on other storage types as well and not just a blockchain ledger. For example, any data store such as a database, relational database, topic-based server, cloud platform, distributed database, and the like, may be used.

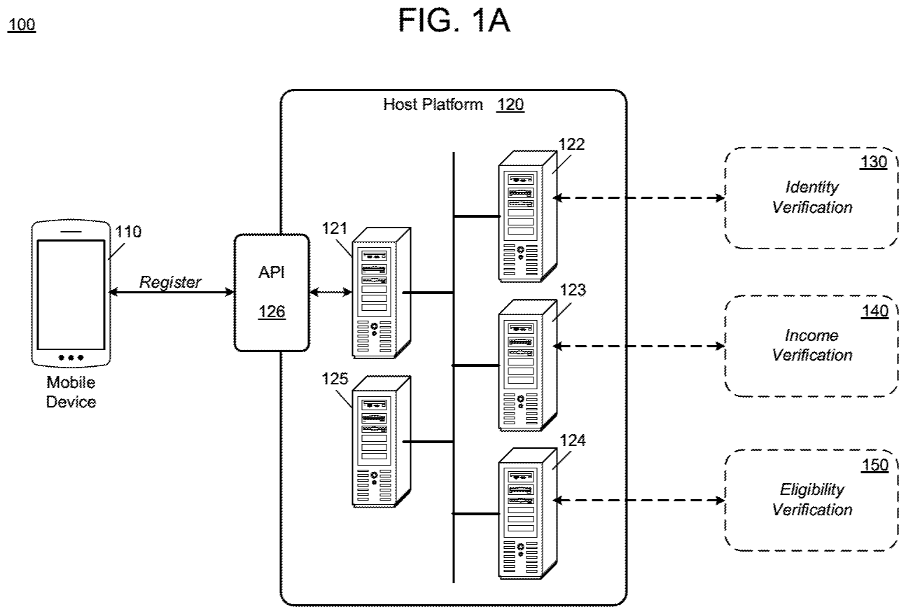

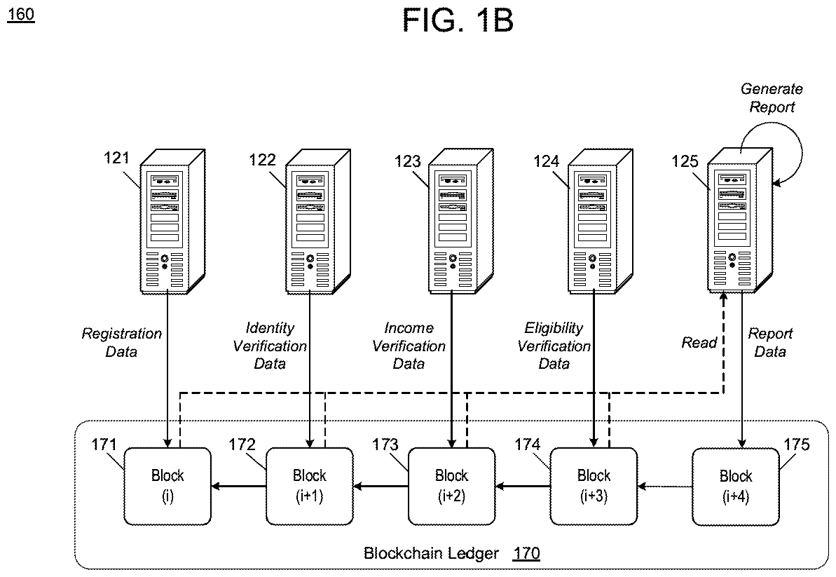

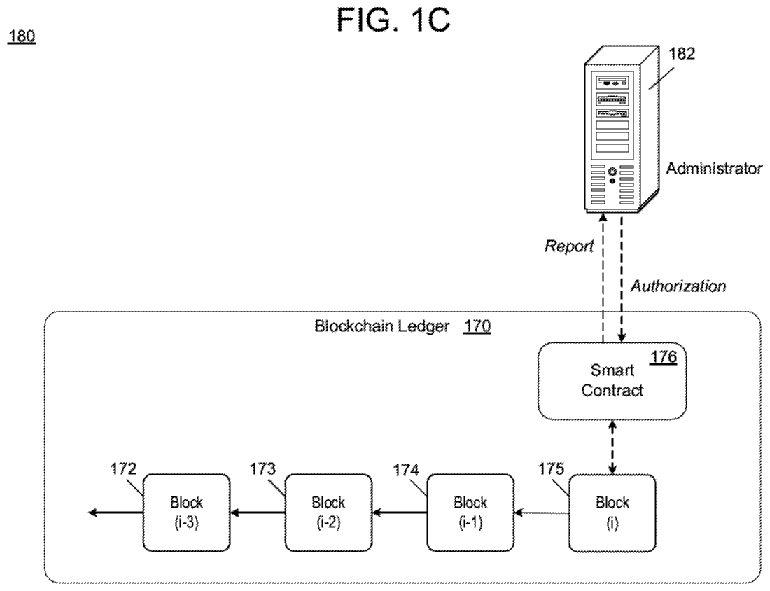

FIGS. 1A-1C illustrate examples of a host platform 120 that is configured for eligibility verification and benefit administration in accordance with example embodiments. As an example, the host platform 120 may include one or more of an application server, a cloud platform, a blockchain network, and the like. In this example, the host platform 120 is a blockchain-enabled network with a plurality of blockchain-enabled peers 121, 122, 123, 124, and 125, however, embodiments are not limited to a blockchain-based environment. As another example, a centralized architecture such as a web server, a cloud platform, or the like, may be included in the host platform 120. Each of the blockchain-enabled peers 121-125 may include a blockchain software application, package, and/or suite installed therein that establishes or otherwise provides access to a shared blockchain ledger and provides address information for each of the blockchain-enabled peers 121-125. Also, the peers 121-125 may cooperate in the management of the blockchain ledger, but the blockchain ledger may be managed by another set of peers.

The host platform may ingest or otherwise collect data of the user via an application programming interface (API) 126. For example, the user may provide account identifiers of bank accounts, credit card accounts, checking accounts, debit card accounts, payroll-related accounts, and the like. The user may also provide access credentials and approve the host platform 120 to access their account information online. In addition, the user may submit account statements, payroll-related documentation, and the like via the API 126. The host platform 120 may use the account numbers and access credentials to ingest data from various external sources (e.g., the host financial institutions of the accounts, etc.), which may be accessed via one or more external APIs, etc.

In the example embodiments, the host platform 120 may make one or more verifications of a user when determining whether the user is eligible for a disbursement of a benefit, such as basic income or other funds. The verifications may include one or more of an identity verification 130, an income verification 140, eligibility verification 150, and the like. During the verification processes, the host platform 120 may execute one or more machine learning models that receive data content of the user as input and output predicted results. In one example, the predicted output may be a predicted, imputed, inferred, extracted, or otherwise estimated attribute of a transaction record where the attribute is not expressly included in the content of the transaction record. The predicted, imputed, inferred, extracted, or otherwise estimated attribute can be used to enhance the transaction record with additional details of the transaction. Furthermore, the “enhanced” transaction record can be easier to match with other transactions, because additional data points now exist.

FIG. 1B illustrates a process 160 of the host platform 120 committing verification data to a blockchain ledger 170, although many embodiments could instead send verification data to another platform and/or network of blockchain-enabled peers, which can perform voting, other consensus-based protocols, and the like. Referring to FIG. 1B, the host platform 120 that was shown in FIG. 1A includes a plurality of blockchain-enabled peers 121, 122, 123, 124, and 125 that may perform and/or facilitate the verification processes. In some cases, multiple peers may perform the same verification process and confirm with each other via a consensus mechanism such as a blockchain endorsement process based on an endorsement policy (e.g., requirements, conditions, rules, etc.), which can be embodied within a blockchain smart contract configured to read and write data to the shared blockchain ledger. As another example, one or more of the peers may perform different verification processes at the same time enabling parallel verification of multiple types via multiple systems simultaneously. In the example of FIG. 1B, the blockchain-enabled peer 121 registers a user (onboards them) onto the blockchain network; blockchain-enabled peer 121 may perform this onboarding onto the blockchain network as part of the administration and verification platform onboarding process. During the administration and verification platform onboarding process, the user may download and install a copy of a mobile application or open a web browser and navigate to a web application via a URL. In response to prompts from an application, the user may be required to provide registration information such as details about the user including name, address, email, contact, etc. and also may be required to create a username and password.

In addition, the user may provide login credentials or other access means, such as keys, tokens, smart-contract-based credentials, and the like, which enable the host platform to establish an authenticated channel with the user's financial institutions to inspect transaction records from the user's account or accounts, an employer, a payroll provider of the employer, and the like. Also, the user may provide permission to the host platform to access corresponding user records held by any of the user's financial institutions, employer, payroll provider, benefit administration programs, and the like. The blockchain-enabled peer 121 may record the user data obtained from the registration process, including the user's details, in a blockchain transaction stored within a block 171 which is committed to the blockchain ledger 170.

In some cases, the host platform may create a separate instance of a blockchain for each user. In this example, the block 171 would be a genesis block (first block of the blockchain—or block zero) for that specific user upon initial user registration and account creation. As another example, multiple users and their data may be intertwined within the same blockchain, which naturally has a single genesis block, instead of a genesis block per user.

Referring back to FIG. 1A, blockchain-enabled peer 122 executes an identity verification process 130 based on the data onboarded by the user including data ingested from the user data records held by the user's financial institutions, employer, payroll provider, and the like. In other embodiments, blockchain-enabled peer 122 could interface with a separate platform that performs identity verification, or be responsible for any and all parts of the administration and verification process. Examples of the identity verification process 130 are described in U.S. patent application Ser. No. 17/580,721, filed on Jan. 21, 2022, in the United States Patent and Trademark Office, the entire disclosure of which is incorporated herein by reference for all purposes. In addition, examples of identity verification are described herein below. The results of the identity verification process 130, including a pass/fail status of the identity verification, identifiers of any data records that have incorrect data, other identities linked to the user, and the like, may be recorded by the blockchain-enabled peer 122 in a block 172, which is committed to the blockchain ledger 170. In some embodiments, the identity verification process may include one or more fraud detection processes, such as geographical verification, suspicious activity detection, and the like.

Blockchain-enabled peer 123 executes an income verification process 140 based on the data onboarded by the user including data ingested from the user transaction records held by the user's financial institutions, employer, payroll provider, and the like. Examples of the income verification process 140 are described in U.S. patent application Ser. No. 17/580,721, filed on Jan. 21, 2022, in the United States Patent and Trademark Office, the entire disclosure of which is incorporated herein by reference for all purposes. In addition, examples of income verification are described herein below. The results of the income verification process 140 may be recorded by the blockchain-enabled peer 123 in a block 173 which is committed to the blockchain ledger 170. For example, the result may include a pass/fails status, identifiers of any suspicious data records, identifiers of any other users, and the like.

Blockchain-enabled peer 124 executes an eligibility verification process 150 based on the data onboarded by the user including data ingested from the user transaction records held by the user's financial institutions, employer, payroll provider, and the like. The eligibility verification process may be conditioned on approval by successful execution of the identity verification process 130 and/or the income verification process 140, including any instances of fraudulent behavior that are detected during either verification process. The eligibility verification process 150 may compare information about the user's assets, income, identity, geography, and the like, to requirements for eligibility set forth by the benefits program that the user wishes to obtain benefits from. A result of the eligibility determination may be recorded in a block 174 committed to the blockchain ledger 170. The result may include a pass/fail eligibility determination, an indication of any requirements that the user does not satisfy and why, and the like.

As an example, the blockchain-enabled peer 124 may identify a geographic location of the user based on various data records that are obtained during the registration process or pulled/ingested from connected user accounts (such as bank accounts, etc.) to determine a geographical location where the user is currently residing. This location can then be compared to any geographical requirements of the benefit program. As another example, the blockchain-enabled peer 124 may identify a pattern of income (e.g., monthly, weekly, etc.) for the user based on transaction records which are ingested from connected financial accounts of the user and compare the income to any income requirements of the benefits program.

Blockchain-enabled peer 125 may read the user's onboarded data from block 171, the identity verification results from block 172, the income verification results from block 173, and the eligibility verification results from block 174 and generate a report which includes human-readable information about the results of the different verifications and the eligibility check. The report data and other output may be stored within a digital document that is encrypted and stored within a block 175 on the blockchain ledger 170.

As illustrated in FIG. 1C, the blockchain-enabled peers may install or otherwise execute a blockchain smart contract 176 for an administrator 182, which enables the administrator 182 to read data from the blockchain ledger 170 via the smart contract 176. For example, the blockchain smart contract 176 may be installed or executed on any of the peers 121-125. The administrator 182 may communicate with the blockchain via smart contract 176 as it executes on the blockchain-enabled peer and request retrieval of any data records of the user including the report generated by blockchain-enabled peer 125 and stored in block 175. The smart contract 176 may be called as it receives the request from administrator 182, access the data from any of the blocks or a state database of the blockchain ledger 170, and return the information to the administrator 182.

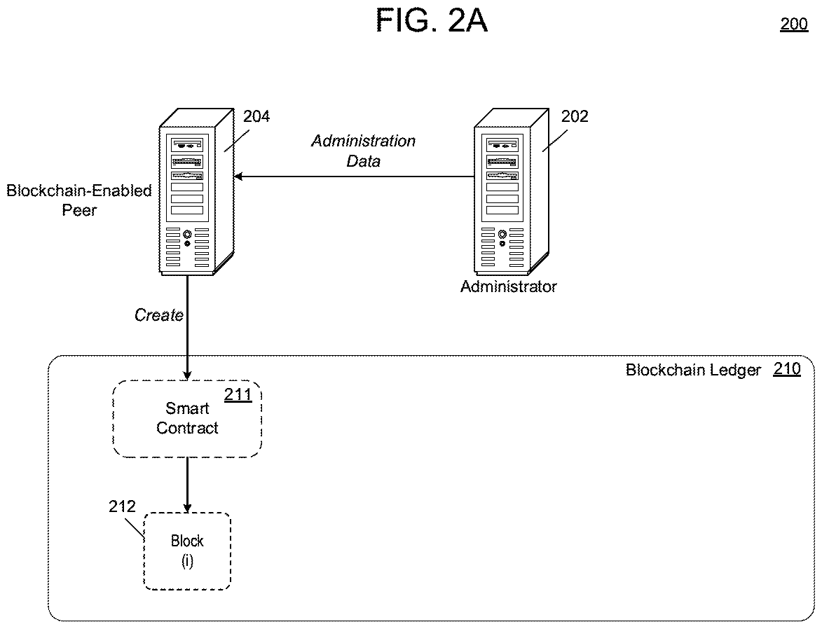

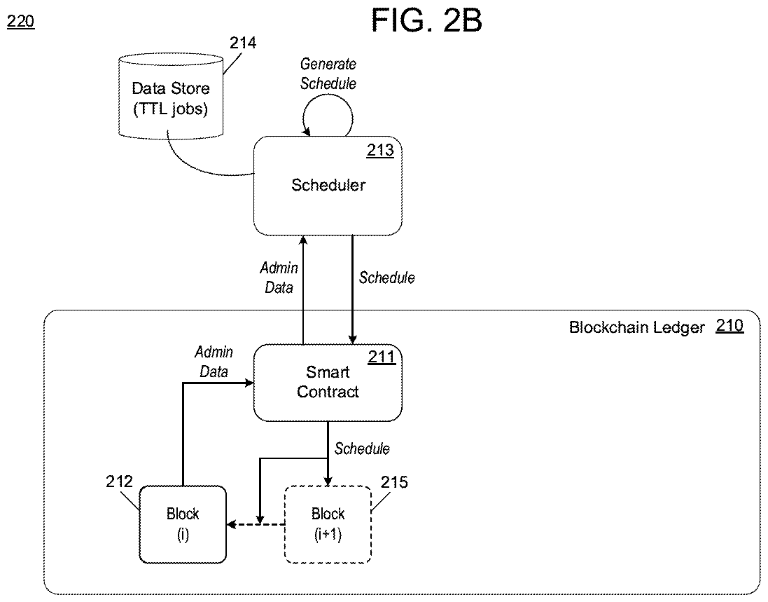

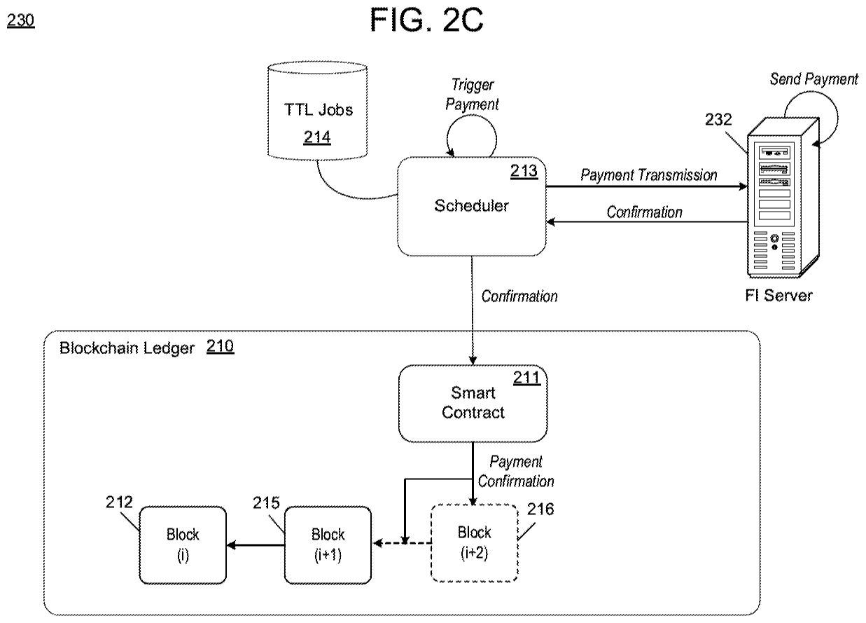

FIGS. 2A-2C illustrate a process for automated distribution of a benefit in accordance with example embodiments. The process described in FIGS. 2A-2C may be performed by the host platform 120 as described in FIG. 1A, or a different host platform, or a combination of host platforms. Referring to FIG. 2A, there is shown a process 200 of creating and installing a blockchain smart contract 211 on a blockchain ledger 210 of the host platform in response to a request to start a new benefit disbursement for a user (not shown). For example, a blockchain-enabled peer 204, which manages a blockchain ledger 210 along with other blockchain-enabled peers (not shown), may receive a message or other request from a server or other system of a plan administrator (administrator 202). The message may include payment disbursement information for a registered user of the host platform (e.g., a user that has been onboarded as described in FIG. 1B, or the like).

In response to receipt of the request, the blockchain-enabled peer 204 may create, install, and/or execute a smart contract, which can be deployed in the form of chaincode onto the blockchain ledger 210. The smart contract 211 may be configured to read and write from the blockchain ledger 210. The content of the smart contract 211, including the underlying code of the smart contact 211, may be written to a block 212 on the blockchain ledger 210. Other information about the plan such as connected payment accounts, dates, amount of funds, and the like, may be included within the block 212 as well. Although not shown, each new block added may be approved via a blockchain consensus process such as a validate, order, and commit process, as is known in the art of blockchain.

FIG. 2B illustrates a process 220 of scheduling future disbursements of a benefit under a benefit administration plan based on a scheduling program 213, which may be installed and executing on the blockchain-enabled peer 204 shown in FIG. 2A, or it may be installed and executing on an external system that establishes an authorized communication channel to the blockchain ledger 210 via the smart contract 211 or the like. In this example, the scheduler 213 may invoke the smart contract 211 to read benefit administration data of the user from the block 212. Although not shown in FIG. 2B, the smart contract 211 may also read the data from a state database (not shown), such as a world state database that includes only the most recent values (i.e., current values) of the relevant state variables. The smart contract 211 may read payment account information, disbursement dates, disbursement amounts, sending account information, and the like, and the scheduler 213 may use this information to build a schedule for payments under the plan.

For example, the scheduler 213 may create a schedule for distributing payments to the user based on the plan data. The schedule may include one or more payments, such as a plurality of payments that each transfer a benefit of funds/income to the user on a recurring basis (e.g., every week, every 2 weeks, every month, etc.). Each payment may be for the same amount or for different amounts. The resulting schedule may include a table, a file, a document, a spreadsheet, or the like, which may be stored in a block 215 on the blockchain ledger 210 for future auditing purposes. Furthermore, the blockchain can add a hash pointer in block 215 that points to block 212 creating a link between the two blocks 212 and 215. In addition, the scheduler 213 may create timers in the form of jobs such as time-to-live (TTL) jobs, cron jobs, or the like. The jobs may be stored in a data store 214. Each job may have a timer that expires at a particular point in time in the future. As an example, when the timer expires, the job may send a message to the scheduler 213 causing the scheduler 213 to invoke a payment as further described in FIG. 2C.

In particular, FIG. 2C illustrates a process 230 of the scheduler 213 triggering a payment to a user via a financial institution (FI) server 232 of the user. Here, the scheduler 213 receives a message from a time-to-live job indicating that the job has expired and that the benefit is to be paid. Here, the scheduler 213 may read the details of the payment from the previously created schedule and send an instruction to the FI server 232 to disburse a payment to the user via an electronic payment network such as commonly used for financial transactions including credit card, debit card, checking, cash, and the like. Furthermore, the FI server 232 may confirm that the payment has been sent and/or received and transmit the confirmation back to the scheduler 213. Furthermore, the scheduler 213 may send a call or other instructions to the smart contract 211 which writes the payment information and the confirmation to a block 216 on the blockchain ledger 210. Here, the block 216 may include a hash pointer to the previous block 215. As a result, the host platform described herein can verify the eligibility of a person who is scheduled to receive a benefit such as basic income, and also automatically disburse such payments to verified users.

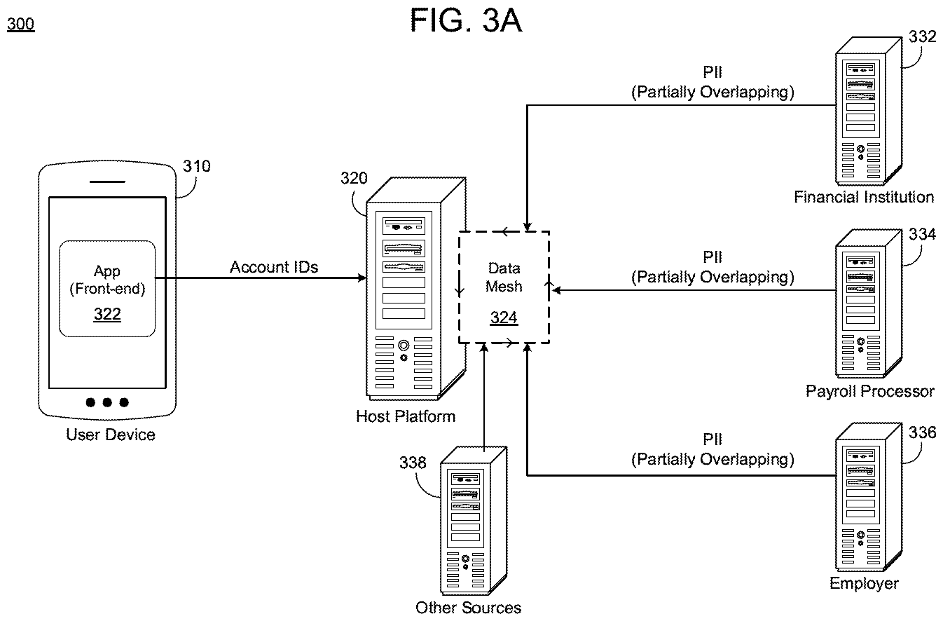

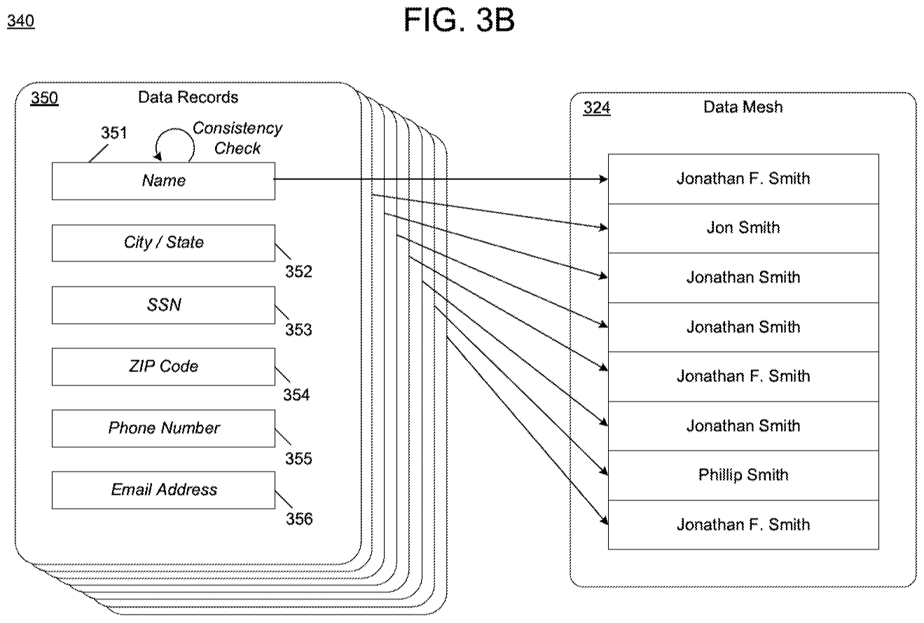

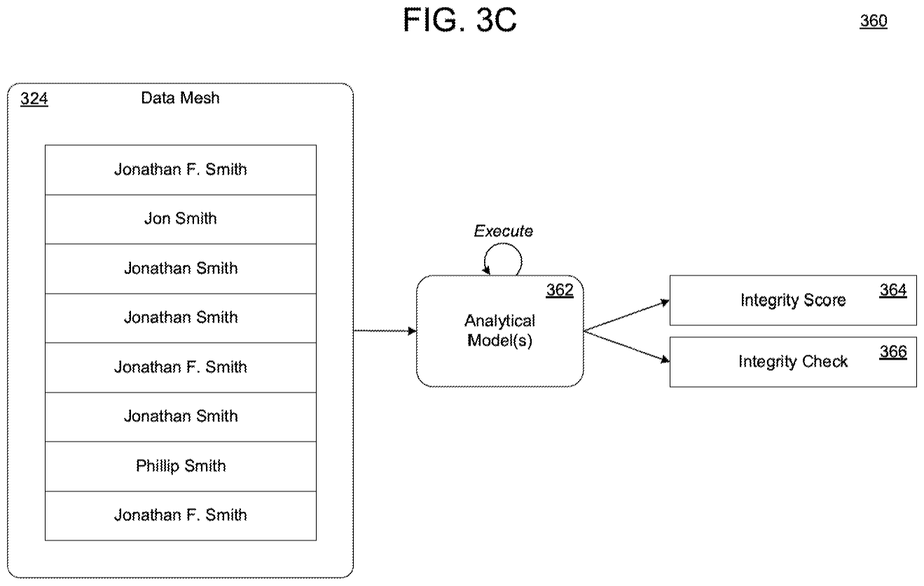

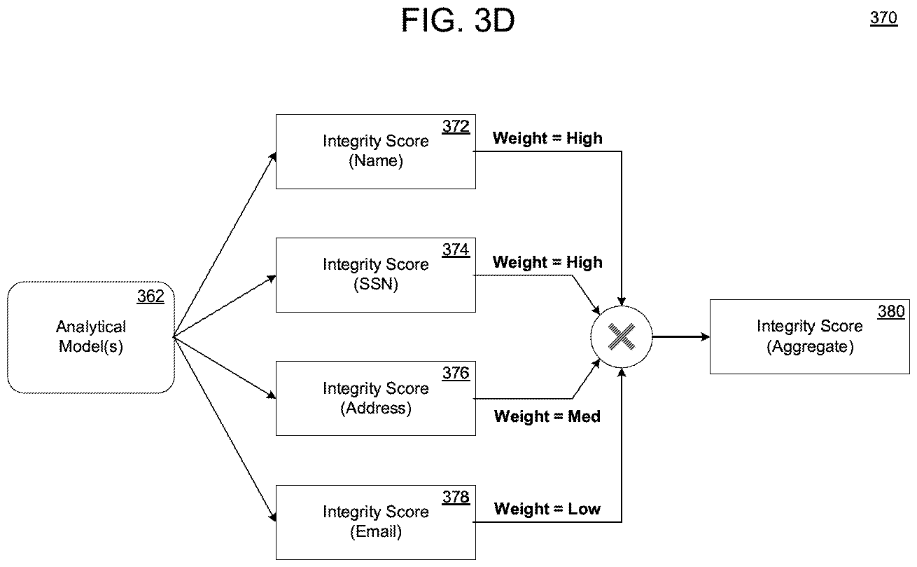

FIG. 3A illustrates a data ingestion process 300 of a host platform 320 in accordance with example embodiments. The data ingestion process 300 may be performed by a blockchain-enabled peer such as those shown in FIG. 1A, a server, a cloud platform, a combination of systems, networks, devices, etc., and the like. In some embodiments, an application server that is coupled to the blockchain network shown in FIG. 1A may perform the data ingestion process 300. As another example, a smart contract or other software program installed on a blockchain-enabled peer and/or a blockchain ledger may perform the data ingestion process.

In this example, the host platform 320 may host an application that performs identity and/or income verification such as described herein. Here, a front-end 322 of the application may be downloaded from a marketplace, etc., and installed on a user device 310 such as a mobile device, a smart phone, a tablet, a laptop, a personal computer, etc. It should also be appreciated that the host platform 320 may host a web application, a website, an authentication portal, or the like, which can receive additional input from the user such as account numbers, identity information, images, and the like.

In this example, a user may input account numbers and/or routing numbers, login credentials, or the like, of bank accounts, employer accounts (e.g., gig employers, etc.), payroll company accounts, credit accounts, etc., held by trusted sources of truth such as banks, credit agencies, payroll processors, employers/organizations, institutions, and the like, into one or more input fields displayed within a user interface of the front-end 322 of the application and submit them to the host platform 320 by clicking on a button or the like within the user interface of the front-end 322. For example, the user device 310 and the host platform 320 may be connected via the Internet, and the front-end 322 may send the information via an HTTP message, an application programming interface (API) call, or the like. When the account identifiers are transmitted, a response containing relevant account information and the like may be received.

In response to receiving the account information, the host platform 320 may register/authenticate itself with various trusted sources of truth where the accounts/user accounts are held/issued. For example, the host platform may perform a remote authentication protocol/handshake with a financial institution server 332, a payroll processor server 334, and an employer server 336, another data source 338, and the like, based on user account information that includes an account issued by the bank, a source of funds from the payroll processor, and an employer that pays the user. These accounts provide the host platform with a unique mesh of partially-overlapping data sets that can be combined into one larger data set and analyzed. In the example embodiments, the combination of data from the different sources of truth (e.g., financial institution server 332, the payroll processor server 334, the employer server 336, and the other sources 338) can be combined into a data mesh 324 by the host platform 320. It should also be appreciated that the user may manually upload data such as documents, bank statements, account credentials, and the like, in a format such as a .pdf, .docx, spreadsheet, XML file, JSON file, etc. Furthermore, optical character recognition (OCR) may be performed on any documents, files, bank statements, etc. obtained by the host platform 320 to extract attributes from such documents and files.

The authentication process may include one or more API calls being made to each of the different third-party services (e.g., bank, payroll, employer, etc.) via a back-end of the software application on the host platform 320 to establish a secure HTTP communication channel. For example, the back-end of the software application may be embedded or otherwise provisioned with access credentials of the user for accessing the different third-party services. The back-end may then use these embedded, provisioned, and/or otherwise securely stored credentials to establish or otherwise authenticate itself with the third-party services as an agent of the user. Each authenticated channel may be established though a sequence of HTTP communications between the host platform 320 and the various servers. The result is a plurality of web sessions between the host platform 320 and a plurality of servers, respectively. The host platform 320 can request information/retrieve information from any of the servers, for example, via HTTP requests, API calls, and the like. In response, the user data can be transmitted from the servers to the host platform 320 where it can be combined the data mesh 324 for further processing.

FIGS. 3B-3D illustrate a process of verifying a user based on personally-identifiable information (PII) in accordance with example embodiments. The process may be performed by a blockchain-enabled peer, as well as any other server or host platform mentioned herein. Referring to FIG. 3B, there is shown a process 340 of performing a consistency check on a particular field of PII (i.e., a name value) stored in each of a plurality of data records obtained from multiple sources of truth. Referring to FIG. 3B, a corpus of data records 350 is shown. Here, each of the data records may have some form of PII, such as a name value 351, a city/state value 352, SSN value 353, ZIP Code value 354, phone number value 355, email address value 356, and the like.

In this example, a value for name 351 is separately identified from each (or most) of the data records, and compared to each other for consistency across records. Here, the corpus of data records 350 can be read by the host platform to identify name values 351 in each of the data records. The name values 351 can be extracted and stored in a table, a file, a document, or the like, and stored together in the same file, record, or other instantiation of a data structure, or the like, within the data mesh 324. If one or more data records do not have a name value, they can be ignored or omitted, or their absence can be part of the consistency checking process and algorithm. In this example, eight (8) name values are identified from PII included in eight different data records where some of the records are from various/differing sources of truth. The name values can be stored in the same file, record, or other instantiation of a data structure, or the like, in the data mesh 324 by the host platform even though they are extracted from different records. It should be further appreciated that in some embodiments, name values can be aggregated by source or account, for example, grouping transaction records to compare names associated with a plurality of different accounts, financial institutions, or the like.

FIG. 3C illustrates a process 360 of analyzing the data mesh 324 including the name values for consistency. In this example, components of the data mesh 324 can be input into one or more analytical models 362, such as a machine learning model, heuristic, or statistical model, which can perform a consistency check. As a non-limiting example, the analytical models 362 may be machine learning models such as fuzzy matching models, similarity assessments, Natural Language Processing (NLP) techniques, or the like. In this example, the purpose of the analytical model 362 is to determine how different/similar the name value is across the different data records. The file with the different name values stored in the data mesh 324 may be vectorized (via converting text-based components or features into a sequence of numeric values, etc.), making it possible for the text to be operated on by a digital computer, including machine learning models, and the like. Here, the name value may refer to just the first name, last name, or a combination of names (including the middle name and/or initial, as well as titles, prefixes, and/or suffixes). An output of the analytical models 362 may be an integrity score value 364 (e.g., a value in the range of 0 to 100, inclusive, etc.) and an integrity check value 366, which is a Yes/No or True/False value that is determined by comparing the integrity score value 364 to a predetermined threshold for that particular field of PII (i.e., for the name in this example). If above the threshold, the integrity check value 366 is set to Yes/True to indicate a passing check, otherwise its set to No/False. If at the threshold, the integrity check value 366 can arbitrarily be set to provide Yes/True or No/False, depending on the strictness policies for the system. As an additional embodiment of this, the analytical models 362 may assign different weights to each data record based on factors such as source of data record, with such weighting being determined through means such as manual configuration or dynamic weighting derived from machine learning models tuned to optimize for predictive validity.

This one consistency check may be enough to perform an identity verification. For example, it may be clear after just one consistency check that this user is not who they claim to be. As another example, it may take multiple different values of PII to be considered. FIG. 3D illustrates a process 370 in which an aggregate integrity score 380 is created. Here, the host platform may perform a respective consistency check for multiple different values of PII simultaneously (in parallel) with one another. For example, each consistency check may be performed in parallel by different cores of a multi-core processor or different threads of another execution engine. As another example, the consistency checks may be performed sequentially, one after the other, or otherwise batched.

In FIG. 3D, four different integrity scores 372, 374, 376, and 378 are generated for four different fields of PII (i.e., name, SSN, address, and email, respectively) across the corpus of data records from the data mesh. Furthermore, the integrity scores 372, 374, 376, and 378 can be individually weighted differently (if desired, and including the possibility of zero-valued weights) and then aggregated together and potentially normalized to a predetermined scale by a function or model to create the aggregated integrity score 380. This aggregated integrity score 380 can be used to make a final decision on whether the identity of the user is verified or whether it is not.

Based on one or more integrity scores, the back-end of the software application may make a decision of Yes or No that the identity is verified. This information may be used to modify or otherwise annotate via reference the original corpus of data records in the data mesh to include a value for such a decision. As another example, the identity verification process result, such as one or more of the integrity scores, may be an input into a decision by the back-end of the software application on whether to activate a new account with the software application based on the identity verification determination. Here, the host platform may only activate the account when the integrity score and/or integrity check values satisfy predefined thresholds. If so, the activation may enable the user to participate in the software application as an active user. This may give the user rights to send messages to other users of the software application, create an account profile, browse web listings, browse employment opportunities, prepare benefit-related applications, and the like.

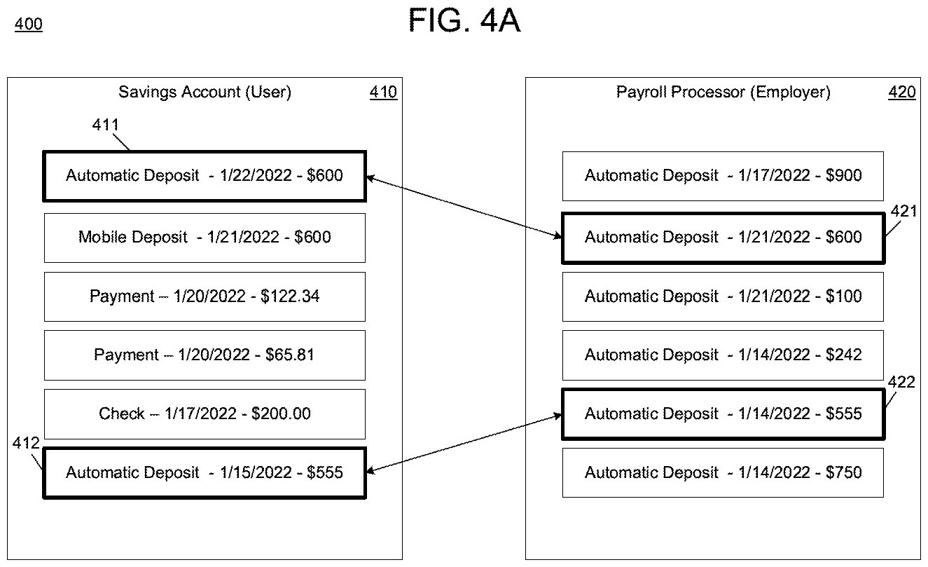

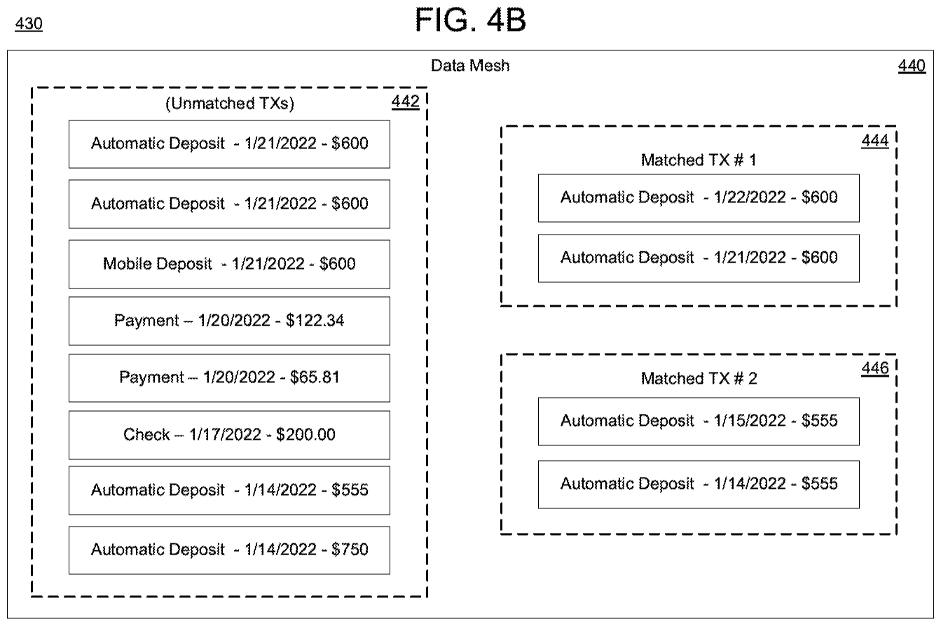

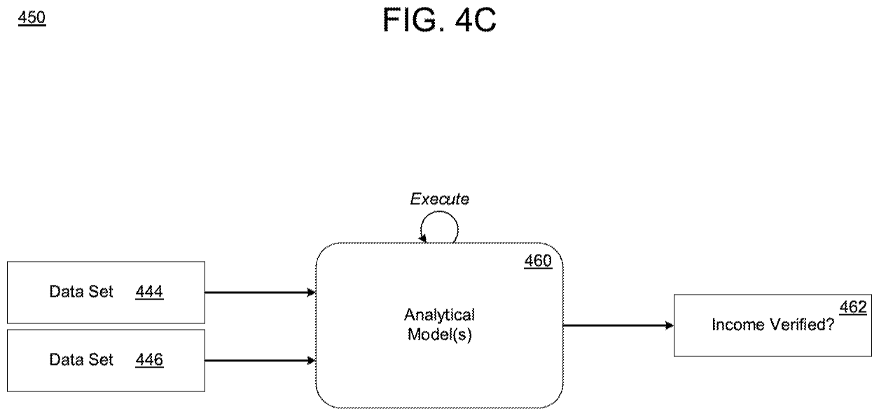

FIGS. 4A-4C illustrate a process of verifying income-based records in accordance with example embodiments. The process may be performed by a blockchain-enabled peer, as well as any other server or host platform mentioned herein. For example, FIG. 4A illustrates a process 400 of comparing partially overlapping transaction records from data sets 410 and 420, respectively. In this example, the transaction data sets 410 and 420 are from two different financial accounts including a user's savings account and a payroll processor payment account associated with the user's employer, respectively. In this example, the host platform may perform a transaction string cleaning process as described in U.S. patent application Ser. No. 17/342,622, filed on Jun. 9, 2021, in the United States Patent and Trademark Office, and a transaction reconciliation and deduplication process as described in U.S. patent application Ser. No. 17/835,044, filed on Jun. 8, 2022, in the United States Patent and Trademark Office, the entire disclosures of which are incorporated herein by reference for all purposes.

In the example of FIG. 4A, the host platform detects that a transaction 411 in the user's savings account matches/corresponds to a transaction 421 in the payment account of the payroll processor. Likewise, a transaction 412 in the user's savings account corresponds to a transaction 422 in the payment account of the payroll processor. In other words, the host platform detects that two transaction records within account summaries of the two accounts hosted by the trusted sources correspond to each other (i.e., they are from the same financial transaction). In this case, the two accounts may be the opposite sides (i.e., counterparties) of a financial transaction (e.g., payor and payee). As another example, both accounts may be user accounts and the corresponding transaction records may be duplicates or copies with differences that result from the different financial entities processing the transactions.

Based on the results of the detection process, the host platform may create different files or records within the data mesh as shown in the process 430 of FIG. 4B. In this example, the host platform generates three data sets including an unmatched transaction data set 442, a first matched transaction data set 444, and a second matched transaction data set 446, within data mesh 440 of the host platform.

Thus, the host platform of the example embodiments is able to read through or otherwise process transaction data sets from different trusted sources and identify common/linked transactions between two or more transaction data sets. In other words, the host platform identifies transactions that overlap and/or otherwise correspond. This redundancy and/or correspondence can be used for verification purposes as noted by the above-incorporated patent applications.

FIG. 4C illustrates a process 450 of processing the second and third data sets 444 and 446 from the data mesh via an analytical model 460. An output 462 of the analytical model 460 could be a determination of whether the transactions are indeed income related, whether the income attributed to the transactions is verified, or the like. In the case of output 462, the output is a determination of whether or not income is verified. For example, the output 462 may include a score, a Yes/No evaluation or other binary value, and the like. The host platform may clean the data in the data mesh so that other parts of the system or systems can access and process the data as desired (e.g., via fraud detection and income verification, or another combination of verification platform assessments and/or checks). FIG. 4C can be seen to represent how the income verification process can combine all the pieces together to deliver an output. For example, the process might use Identity Verification with certain thresholds, perform Transaction Integrity Checks with other thresholds, and decide to not use geographic verification, etc.

Prior to and/or during the income verification process described in the examples of FIGS. 4A-4C, the host platform may also enhance the transaction records through a process referred to as transaction string cleaning. The transaction strings contained in the transaction records can be analyzed to identify additional details of the transaction that are not expressly present in the transaction record or the transaction string, including counterparty names, geographic location, transaction types, transaction classifications, etc.

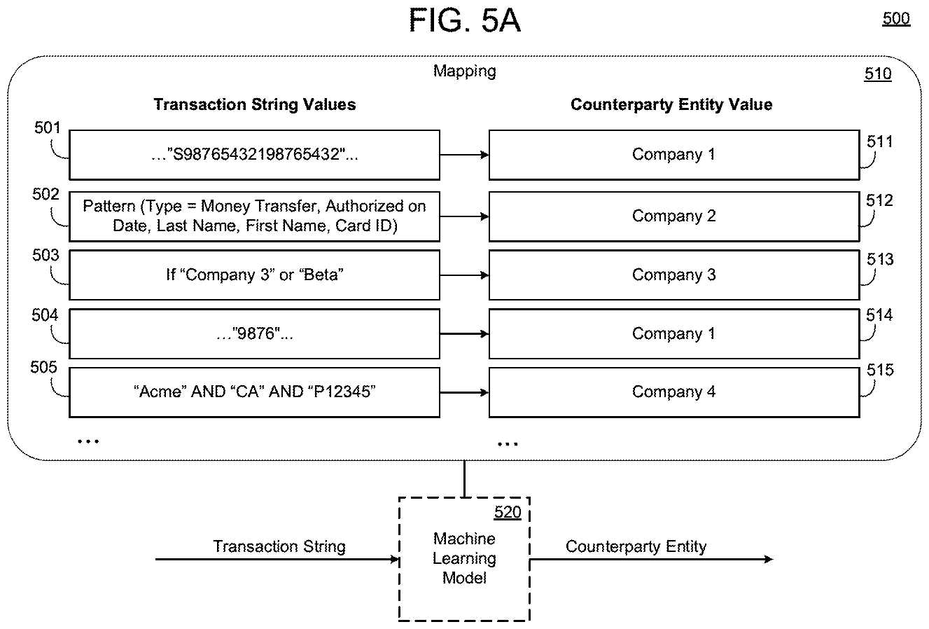

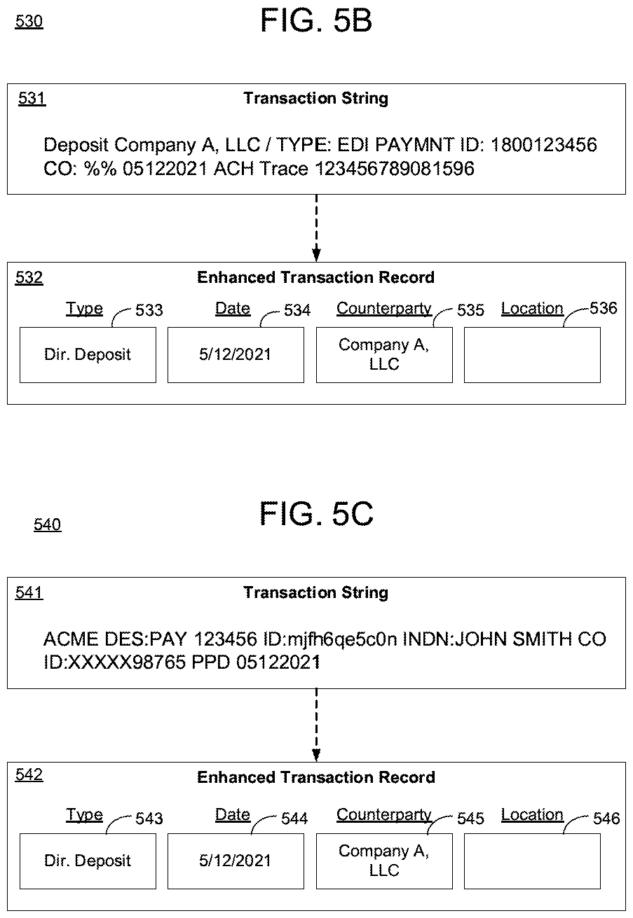

FIG. 5A illustrates a process 500 of mapping transaction strings from transaction records to counterparty entities via a machine learning model 520 in accordance with an example embodiment. As described herein, a counterparty refers to a party of the transaction (e.g., a payor, etc.) when viewed from a transaction record of another party to the transaction (e.g., a payee, etc.). Therefore, the payee may have an account summary with transaction records including payments from the payor who is the counterparty to the payee's transaction record. Likewise, the payee is the counterparty to the payor's transaction record. The transaction strings of those payment transactions may not expressly list the name of the counterparty. The transaction string cleaning process may identify such counterparty and use that data when performing the income verification to further enhance the results of the verification process (i.e., to make them more accurate, etc.).

Referring to FIG. 5A, a host platform such as a blockchain-enabled peer may store the machine learning model 520 (or otherwise call the machine learning model 520 if embodied as an external program or service from the blockchain-enabled peer). Here, the machine learning model 520 may be trained from known mappings to learn mapping relationships between transaction strings 501, 502, 503, 504, and 505 and corresponding counterparty entities 511, 512, 513, 514, and 515, respectively, based on historical mappings which may be manually entered or previously mapped by the machine learning model 520. It should also be appreciated that other aspects of the transaction record (besides the transaction string or in addition to the transaction string) may be mapped to a counterparty entity. For example, a payment type, a payment data, a geographical location, etc. may be used to map a transaction record to a counterparty. That is, mappings predicted by the machine learning model 520, which may be confirmed first by a user or a host, may be used to retrain the machine learning model 520, thus creating training improvements from the operating data created by the host platform.

In some embodiments, the machine learning model 520 may be a neural network designed for the task of named entity recognition, which in this case classifies each word in a transaction string as part of a counterpart entity name, or not. The neural network may reason this by observing word placement and linguistic dependencies formed by other words in the transaction string. Accordingly, the machine learning model 520 is able to generalize over any transaction string format, as there are numerous possible formats that hard-coded rules would miss. The only data passed to the machine learning model 520 to make a prediction is the transaction string itself. Of course, some embodiments could include heuristics and/or rules, which may result from or otherwise inform, modify, and/or enhance machine learning models.

In some embodiments, the input may be the transaction string and the output may be the same data structure (e.g., document, file, table, spreadsheet, etc.) in which the transaction string is input with one or more additional values added including the identified counterpart entity and possibly other data such as date, location, payment type, and the like. In this way, the translation service may modify the input file to include a value or multiple values within a data structure thereof that makes it more helpful for processing by an addition analytics service.

FIGS. 5B and 5C illustrate processes 530 and 540, respectively, of translating a transaction string into a counterparty entity value in accordance with example embodiments. Referring to FIG. 5B, a transaction string 531 may be input to the host system (e.g., a blockchain-enabled peer, a server, etc.), and the output may be the enhanced transaction data record 532. The enhanced transaction data record 532 may include a plurality of fields 533, 534, 535, and 536 for storing data values that are extracted, identified, and/or inferred from the transaction string 531. Here, the translation service may identify the counterparty entity is “Company A, LLC”, whose name is explicitly recited within a transaction string 531. In addition, the translation service may identify additional details such as a type of the transaction, a transaction classification (e.g., a reason, explanation, category, or the like), a date of the transaction, a geographic location, or the like. However, in this example, since this is a direct deposit type of transaction, there is no geographic location specified in the enhanced transaction record 532. The resulting data values that are identified by the translation service may be stored within data fields 533, 534, and 535 of the enhanced transaction record 532, while the data field 536 may be left blank or empty.

FIG. 5C illustrates another example of identifying the counterparty entity. Here, a transaction string 541 is input to the host system and an enhanced transaction data record 542 is output. The enhanced transaction data record 542 includes a plurality of fields 543, 544, 545, and 546 for storing data values that are identified and/or inferred from the transaction string 541. Unlike the example in FIG. 5B, in the example of FIG. 5C, the counterparty entity “Company A, LLC” is not expressly listed by name within the transaction string 541. Instead, a payroll processor name (Acme) of the employer is listed within the transaction string. In this example, the machine learning model 520 (shown in FIG. 5A) may be executed on the transaction string 541 to implicitly map one or more substrings within the transaction string 541 to the counterpart entity name (Company A, LLC). For example, the combination of substrings “Acme”, “John Smith” and “8765” may be mapped to the name of “Company A, LLC” by the machine learning algorithm, for example as part of a multi-class classification algorithm; it should be appreciated that the machine learning classifier could also be constructed in the form of an ensemble of machine learning models, e.g. performing a classification. The resulting data values that are identified by the translation service may be stored within the data fields 543, 544, and 545, while the data field 546 may be left empty or blank, since there is not a clear geographic location of the direct deposit. However, the host platform may fill in or otherwise specify or approximate values for the location fields 536 and/or 546, should the geographic location of the user be identified from the transaction records, including the transaction string and other information included in the transaction records.

In addition to enhancing the transaction records, the host platform described herein may “reconcile” transaction records prior to and/or during the income verification process described in FIGS. 4A-4C. The reconciliation process may identify matching transaction records such as two transactions from balancing or opposing sides of the same transaction and duplicate transaction records from the same side of the transaction. This process may be used to reduce the total number of transaction records that are processed by the income verification process. Furthermore, the process may identify “balancing” transactions that represent two sides of the same transaction. These “balanced” transactions can be used to verify that the same amount of money that was sent to a person was the same amount of money that was deposited. This can also be used to confirm that income was sent and received.

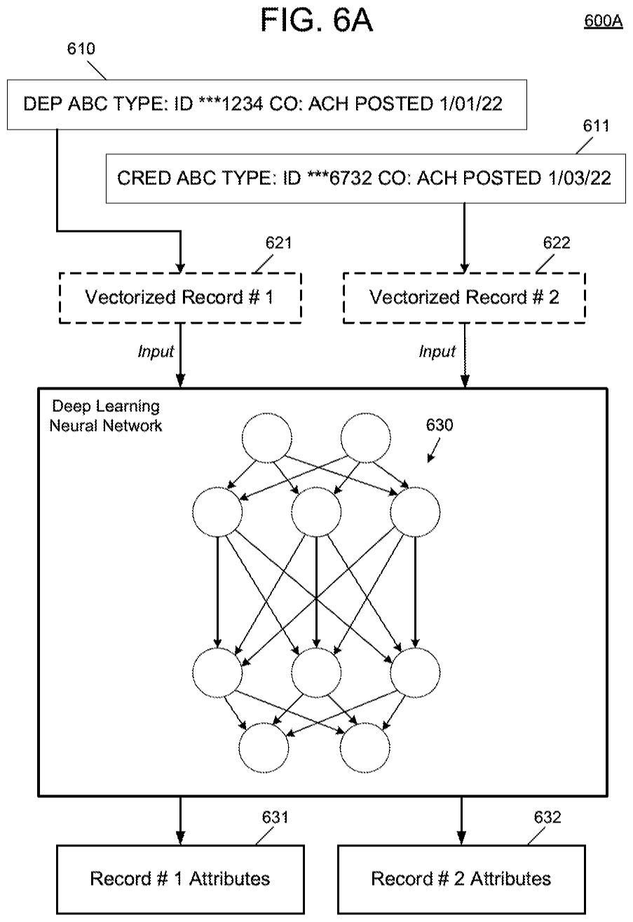

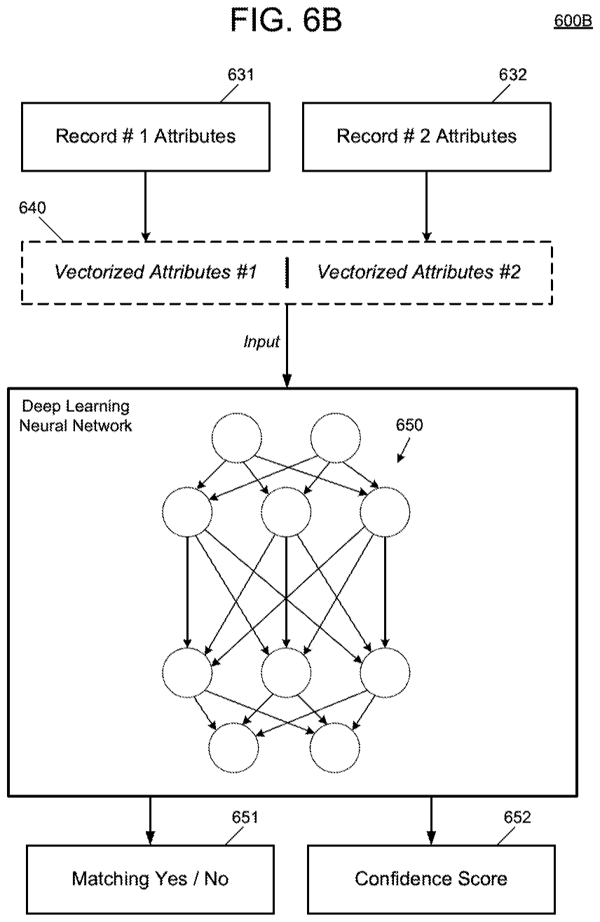

FIGS. 6A and 6B illustrate an example of two machine learning processes that are performed by two machine learning models that work in sequence. However, it should be appreciated that both processes may be performed at the same time by the same machine learning model. In other words, the examples of FIGS. 6A and 6B are not meant to limit the possible use of machine learning by the example embodiments, but merely for purposes of example. The machine learning models described herein may be integrated within a larger machine learning service that is also hosted by the host platform and that can be accessed via application programming interface (API) calls or the like, on the host platform. For example, an API call may specify a particular type of machine learning model to execute from among a plurality/catalogue of machine learning models, heuristics, and/or machine-learning-generated/informed heuristics. The API call may also include the input data (such as the transaction string, etc.) to be processed by the machine learning model/service.

FIG. 6A illustrates a process 600A of a machine learning model identifying transaction attributes from a transaction record in accordance with an example embodiment. FIG. 6B illustrates a process 600B of a machine learning model matching together two transaction records based on the transaction attributes identified in FIG. 6A, in accordance with an example embodiment. As described in these examples, the transaction “attributes” may be considered to be concrete values for transaction “parameters” described herein throughout. Both processes may be executed by the host platform (e.g., a blockchain-enabled peer, a web server, etc.).

Referring to FIG. 6A, the host platform may select two transaction records 610 and 611 from two different digital documents (e.g., two different bank statements, etc.), from records in a data pull spanning a range of dates not necessarily corresponding to statement periods, etc. These two transaction records 610 and 611 may be processed to identify whether these two transaction representations reconcile to the same transaction. Here, the transaction records 610 and 611 are converted into vectors 621 and 622, respectively. The vectorization process may be performed by any known techniques, including natural language processing (NLP), topic modeling, recurrent modeling, bag of words, bag of n-grams, or the like. By converting the contents of the transaction records, which may contain text and other content, into vectors (numerical content), the data can now be input/entered into a machine learning model 630, such as a deep learning neural network or the like.

In response, the machine learning model 630 may identify respective attributes in each of the transaction records. The machine learning model may output transaction attributes 631 identified by the machine learning model 630 from the transaction record 610 and transaction attributes 632 identified by the machine learning model 630 from the transaction record 611. Transaction attributes may include one or more of a payment amount, a payment date, a counterparty entity, a geographical location, and the like. In some cases, no attributes may be identified.

Next, the process 600B may be used to identify whether these two transaction records 610 and 611 reconcile/match a same transaction. Here, the transaction attributes 631 and 632 may be vectorized into a single vector 640 or multiple vectors, and input into a machine learning model 650, which may or may not be a deep learning neural network, other supervised learning model or the equivalent, or any of the other matching models described herein. In response, the machine learning model 650 may output a determination 651 indicating whether or not the two transaction records reconcile to a same transaction and a confidence score 652, indicating a confidence of the prediction (e.g., an accuracy, likelihood, etc.).

When determining whether a user is eligible for a benefit, such as a benefit offered by a basic income benefits program, the host platform may perform one or more of an identity verification, an income verification, a fraud detection, and the like, which are described herein as part of the eligibility verification of a user. The host may also retrieve criteria/qualifications of the benefits program that the user wishes to be certified with and determine whether or not the user qualifies for the benefits program based on the retrieved criteria and user-specific data, such as income data and other data of the user, which may be primarily obtained from authorized accounts of the user.

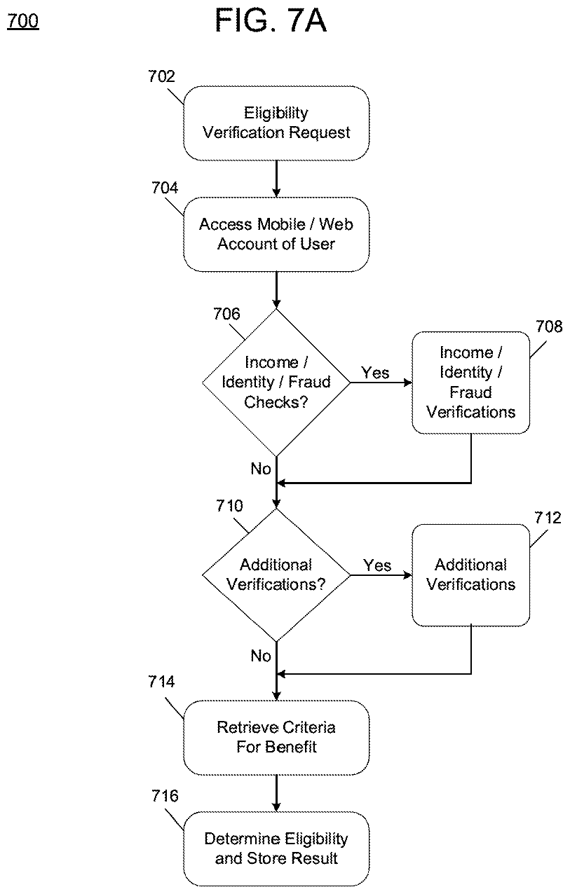

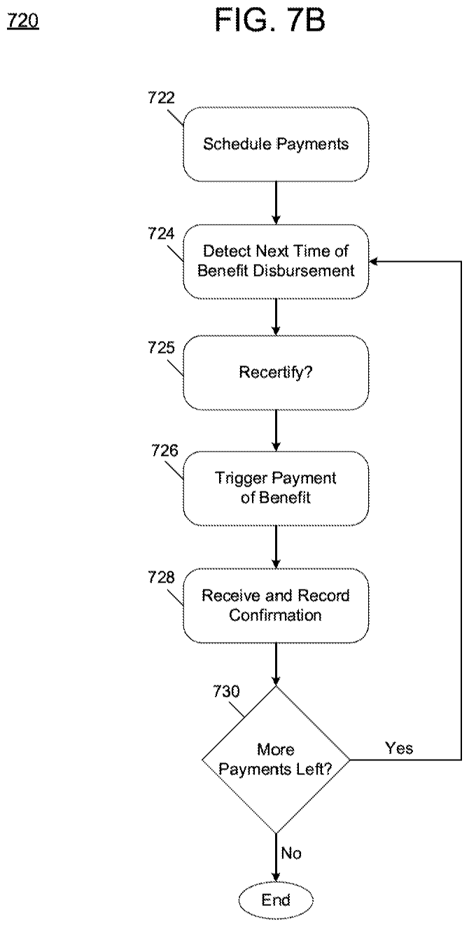

FIG. 7A illustrates a process 700 of verifying eligibility of a user for a benefit in accordance with an example embodiment. The process 700 may be performed by the host platform described herein. At a high level, the process has two main entry points, including one for new users looking to newly certify with a benefits program and one for existing users who need to recertify with the benefits program. In some cases, the existing users may have ongoing basic income grants or the like disbursed on a recuring basis via a scheduler as described herein. This methodology incorporates substantial automation and verification capabilities, including but not limited to means and eligibility criteria (e.g., income, identity, location, other benefits, etc.) testing for new and recertifying users. Additional eligibility checks can be performed as needed, with flexibility for multiple different eligibility check configurations and pathways through the host system, based on user metadata and/or system settings embedded in a policy of the host platform such as within a governance policy of a blockchain, which could be stored in the genesis block of the blockchain ledger, an external reference data store, or the like.

Referring to FIG. 7A, in 702, the process may include receiving a request to verify eligibility of a user for a benefits program. The eligibility may be based on predefined criteria that is defined by the benefits program, such as an unemployment program, a basic income program, a grants program, a disability program, a cash distribution program, and the like. In 704, the process may identify whether the user is a registered user of the application. If so, the process may perform an analysis on a user's profile stored within the application to determine whether or not the user needs to recertify (i.e., have their eligibility reverified). For example, an amount of time since a last certification may be a trigger if too much time has elapsed (e.g., more than a month, etc.). If the user is not an existing user, the user may create a new account with the software application and provide details of accounts that the use wishes to connect to the host platform during an onboarding process.

In 706, the process determines whether the user should have one or more of an identity verification, an income verification, and fraud checks. In some cases, the process may perform all three of these checks or just one or more of these checks. In other cases, it may be configured not to check for these potential concerns, depending on the goals of the distribution program. Furthermore, the fraud checks may be embedded within the identity verification process. If the host system determines to execute one or more of the means tests, in 708 the checks are executed to identify whether the user meets/satisfies any income and/or identity verification requirements of the benefits program based authenticated data pulled from connected accounts of the user (i.e., connected to a host financial server of the accounts along with access credentials for accessing the user's account data). If the host system determines not to perform any checks, the process may skip to 710 without step 708. In 710, the process determines whether any additional checks are needed, such as means checks that may rely upon information gleaned and determinations made in 706 and 708, and in 712, the process can then execute the additional checks. If no additional checks are needed, then the process skips step 712 and moves to 714.

In 714, the process may calculate basic income, guaranteed income, grant, and/or cash benefits payment amounts based on user data and eligibility checks or look up amounts for existing users. If external confirmation is required, e.g. confirmation by a governmental or other agency, the host platform can trigger an external confirmation service via an endpoint of the external confirmation service, which is stored by the host platform. In 716, the process may determine a final assessment regarding the individual's eligibility for basic income, guaranteed income, grant, and/or cash benefits payments. Furthermore, the host system may generate any relevant reports, confirming with external parties as needed, prior to storing relevant information, calculation outputs, and other metadata in databases and optionally entering key information into an appropriate blockchain-based ledger for verifiable storage. In addition, the eligibility verification may be repeated or re-verified over time (e.g., prior to each disbursement, etc.).

FIG. 7B illustrates a process 720 of automatically disbursing benefit payments in accordance with an example embodiment. The host platform described herein may trigger basic income, guaranteed income, grant, and/or cash benefits payments or the like to users. For an existing user, the host platform may determine whether the user needs recertification, and if so, execute a sequence of instructions to perform the steps in the process 700 of FIG. 7A.

The host system may receive a request from the user or from the benefits program to disburse payments in an automated manner to the user. In 722, the host system may schedule payments to be made based on administration data pulled from the user's file, blockchain profile, etc. An ongoing scheduler system may schedule future payments and trigger those payments when the time comes using timers such as those embodied in time-to-live (TTL) jobs, or the like. A calculation system can be configured to a particular set of criteria and goals, using user metadata and system settings. The system can determine an amount to pay to a user and a date on which such payment should be made based on details from the user's administration plan. In 724, the host waits until a next payment disbursement time is detected. For example, the host may detect a timer expiring, a time-to-live job expiring, or the like. In this case, the time-to-live job may have a pointer to a scheduled payment stored by the scheduler. Thus, the time-to-live job may also tell the host platform which payment is to be sent.

In 725, the host platform may determine whether or not the user needs to be re-certified. For example, a benefit may require that the user be re-certified prior to each disbursement or on some periodic basis (e.g., once a year, etc.). The recertification process may be performed to ensure that the user is still eligible for the benefit and may include identity verification, income verification, eligibility verification, and the like.

In 726, the host platform triggers the payment. Furthermore, confirmation with external parties regarding report may be received and recorded in 728. In other words, the financial institution that sends the payment can confirm that the payment was sent and even supply proof in the form of a bank statement, transaction record, etc. In some embodiments, the host platform can confirm, then automatically send payment once confirmed. As another example, the host can automatically send payment based on report criteria. Details of the disbursed payment may be stored in application database storage, and optionally stored in an appropriate blockchain storage location. Blockchain storage can vary by use case, including but not limited to using public, private, or permissioned blockchains individually and in tandem. In 730, the process may determine whether or not any additional disbursements exist for the user under the benefits program. If so, the process returns to step 724, otherwise it terminates.

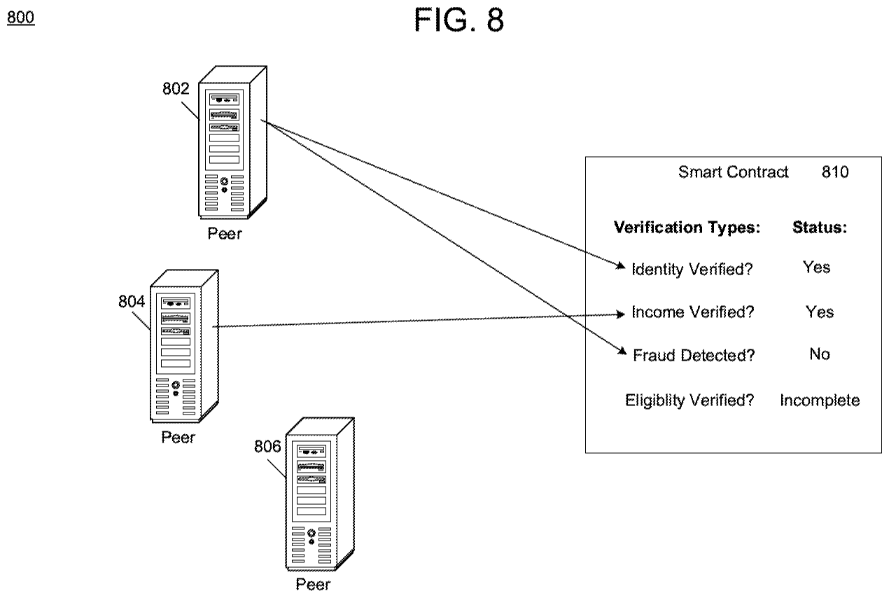

FIG. 8 illustrates a process 800 of updating a verification profile of a user via the host platform. Referring to FIG. 8, a user's verification profile may be embodied in a smart contract 810, which is stored and executed on a blockchain ledger. The blockchain ledger is accessible to each of the blockchain-enabled peers 802, 804, and 806, enabling the plurality of peers to perform separate verification processes at the same time (i.e., overlapping execution times). Each peer involved in the verification processing may write the results to the blockchain ledger. Here, each peer may verify different aspects (or the same aspects, or various combinations of the aspects) of the user's eligibility with respect to the benefit being requested.

In the example of FIG. 8, a first peer 802 has performed an identity verification and a fraud detection process for a user based on data records of the user pulled from a connected account(s). Next, the first peer 802 writes the results into the identity verified field and the fraud detected field of the verification profile within the smart contract 810. Each verification result can be written to the ledger (e.g., in the smart contract 810, via a blockchain transaction in a block, etc.).

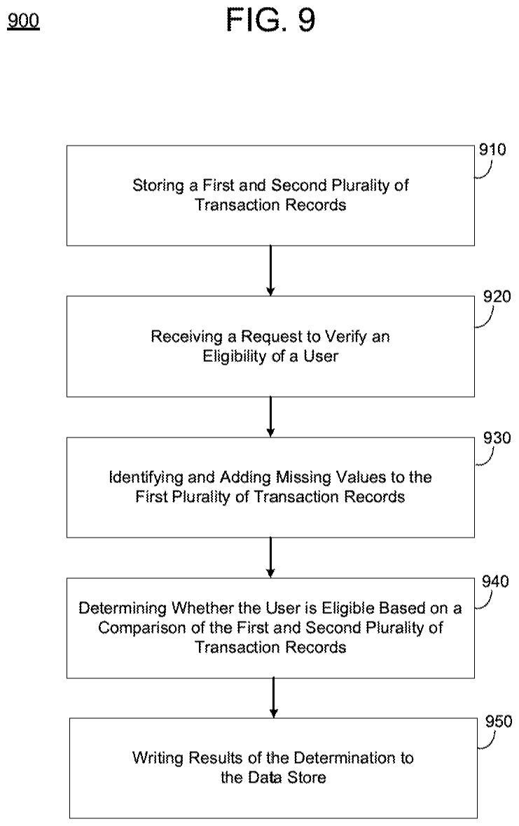

FIG. 9 illustrates a method 900 of eligibility verification and automated benefit distribution in accordance with an example embodiment. For example, the method 900 may be performed by the host platform described herein. Referring to FIG. 9, in 910, the method may include storing a first plurality of transaction records and a second plurality of transaction records, which are associated with a user. In 920, the method may include receiving a request to verify an eligibility of the user. In 930, the method may include executing a machine learning model on the first plurality of transaction records to identify missing values of the plurality of transaction records and adding the missing values to the plurality of transaction records. In 940, the method may include determining whether the user is eligible based on a comparison of the second plurality of transaction records to the first plurality of transaction records with the missing values added, and in 950, writing results of the determination to a data store or relevant blockchain block.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

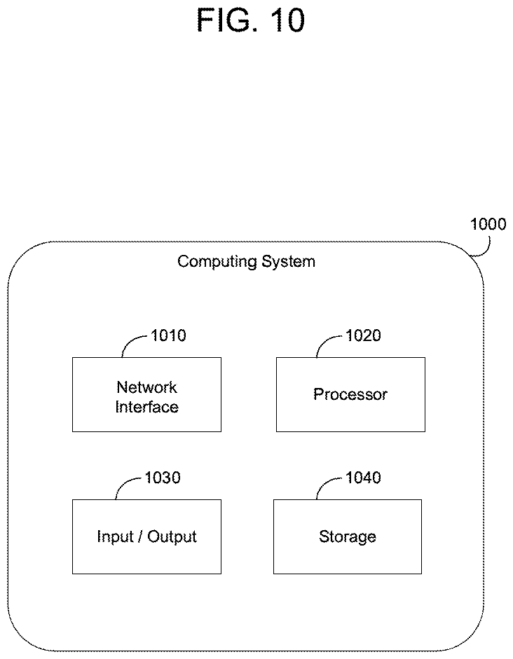

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 10 illustrates an example computing system 1000 which may process or be integrated in any of the above-described examples, etc. FIG. 10 is not intended to suggest any limitation as to the scope of use or functionality of embodiments described herein. The computing system 1000 is capable of being implemented and/or performing any of the functionality set forth hereinabove.

The computing system 1000 may include a computer system/server, which is operational with numerous other general purpose or special purpose computing system environments or configurations. Examples of well-known computing systems, environments, and/or configurations that may be suitable for use as computing system 400 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 1000 may be, contain, or include a tokenization platform, server, CPU, or the like.

The computing system 1000 may be described in the general context of computer system-executable instructions, such as program modules, being executed by a computer system. Generally, program modules may include routines, programs, objects, components, logic, data structures, and so on that perform particular tasks or implement particular abstract data types. The computing system 1000 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 10, the computing system 1000 is shown in the form of a general-purpose computing device. The components of computing system 1000 may include, but are not limited to, a network interface 1010, a processor 1020 (or multiple processors/cores), an input/output 1030, which may include a port, an interface, etc., or other hardware, for receiving a data signal from another device, or for outputting a data signal to another device such as a display, a printer, etc., and a storage device 1040, which may include a system memory, or the like. Although not shown, the computing system 1000 may also include a system bus that couples various system components, including system memory to the processor 1020.

The storage 1040 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 1040 can read and write to a non-removable, non-volatile magnetic media (not shown and typically called a “hard drive”) and/or a solid state drive (SSD). Although not shown, a magnetic disk drive for reading from and writing to a removable, non-volatile magnetic disk (e.g., a “floppy disk”), an optical disk drive for reading from or writing to a removable, non-volatile optical disk such as a CD-ROM, DVD-ROM or other optical media, and/or a flash drive, such as USB drive or an SD card reader for reading flash-based media, can be provided. In such instances, each can be connected to the bus by one or more data media interfaces. As will be further depicted and described below, storage device 1040 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, aspects of the present application may take the form of a computer program product embodied in one or more computer readable medium(s) having computer readable program code embodied thereon.

Although not shown, the computing system 1000 may also communicate with one or more external devices such as a keyboard, a pointing device, a display, etc.; one or more devices that enable a user to interact with computer system/server; and/or any devices (e.g., network card, modem, etc.) that enable computing system 1000 to communicate with one or more other computing devices. Such communication can occur via I/O interfaces. Still yet, computing system 1000 can communicate with one or more networks such as a local area network (LAN), a general wide area network (WAN), and/or a public network (e.g., the Internet) via network interface 1010. As depicted, network interface 1010 may also include a network adapter that communicates with the other components of computing system 1000 via a bus. Although not shown, other hardware and/or software components could be used in conjunction with the computing system 1000. Examples include, but are not limited to: microcode, device drivers, redundant processing units, external disk drive arrays, RAID systems, tape drives, and data archival storage systems, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

1. A computing system comprising:
a data store configured to store a first plurality of transaction records and a second plurality of transaction records which are associated with a user; and
a processor configured to
receive a request to verify an eligibility of the user,
execute a machine learning model on the first plurality of transaction records to identify missing values of the first plurality of transaction records and add the missing values to the first plurality of transaction records,
determine whether the user is eligible based on a comparison of the second plurality of transaction records to the first plurality of transaction records with the missing values added, and
write results of the determination to the data store.

2. The computing system of claim 1, wherein the processor is configured to receive a blockchain transaction with a request to verify the eligibility of the user, and in response, execute one or more of a blockchain query and a smart contract to read the first and second plurality of transaction records from a distributed blockchain ledger and write the results of the determination to one or more distributed blockchain ledger(s).

3. The computing system of claim 1, wherein the processor is further configured to obtain a plurality of data records which store data of the user, extract a value of a target data point from each data record in the plurality of data records to obtain a plurality of extracted values of the user for the target data point, respectively, and determine a consistency of the value of the user for the target data point across the plurality of extracted values of the target data point.

4. The computing system of claim 3, wherein the processor is further configured to determine whether the user is eligible based on the determined consistency of the value of the target data point for the user.

5. The computing system of claim 1, wherein the processor is further configured to execute a second machine learning model on the first plurality of transaction records and the second plurality of transaction records and identify one or more matching electronic transactions included in both the first and second plurality of transaction records based on the executing,
wherein the processor is further configured to determine whether the user is eligible based on the one or more identified matching electronic transactions included in both the first and second plurality of transaction records.

6. The computing system of claim 5, wherein the processor is configured to identify that a first transaction record included in the first plurality of transaction records and a second transaction record included in the second plurality of transaction records are from opposing sides of the common transaction based on a counterparty identity attribute identified from the first transaction record via the execution of the second machine learning model.

7. The computing system of claim 1, wherein, in response to a determination that the user is eligible, the processor is further configured to schedule a plurality of future transactions or disbursements to be executed for the user and store a plurality of time-to-live (TTL) jobs with a plurality of different times corresponding to when the plurality of future transactions are to be executed.

8. The computing system of claim 7, wherein the processor is configured to transmit the plurality of future transactions or disbursements to the user at the plurality of different times based on expirations of the plurality of TTL jobs, respectively.

9. A method comprising:
storing a first plurality of transaction records and a second plurality of transaction records which are associated with a user
receiving a request to verify an eligibility of the user;
executing a machine learning model on the first plurality of transaction records to identify missing values of the plurality of transaction records and adding the missing values to the plurality of transaction records;
determining whether the user is eligible based on a comparison of the second plurality of transaction records to the first plurality of transaction records with the missing values added; and
writing results of the determination to a data store.

10. The method of claim 9, wherein the receiving comprises receiving a blockchain transaction with a request to verify the eligibility of the user via a blockchain-enabled peer of the host platform, and in response, executing one or more of a blockchain query and a smart contract via the blockchain-enabled peer to read the first and second plurality of transaction records from a distributed blockchain ledger, and executing the blockchain smart contract to write the results of the determination to the distributed blockchain ledger.

11. The method of claim 9, wherein the method further comprises:
obtaining a plurality of data records storing data of the user;
extracting a value of a target data point from each data record in the plurality of data records to obtain a plurality of extracted values of the user for the target data point, respectively; and
determining a consistency of the value of the user for the target data point across the plurality of extracted values of the target data point.

12. The method of claim 11, wherein the determining further comprises determining whether the user is eligible based on the determined consistency of the value of the target data point for the user.

13. The method of claim 9, wherein the method further comprises executing a second machine learning model on the first plurality of transaction records and the second plurality of transaction records and identifying one or more matching electronic transactions included in both the first and second plurality of transaction records based on the executing,
wherein the determining further comprises determining whether the user is eligible based on the one or more identified matching electronic transactions included in both the first and second plurality of transaction records.

14. The method of claim 13, wherein the identifying comprises identifying that a first transaction record included in the first plurality of transaction records and a second transaction record included in the second plurality of transaction records are from opposing sides of the common transaction based on a counterparty identity attribute identified from the first transaction record via the execution of the second machine learning model.

15. The method of claim 9, wherein the method further comprises, in response to determining the user is eligible, scheduling a plurality of future transactions or disbursements to be executed for the user and storing a plurality of time-to-live (TTL) jobs with a plurality of different times corresponding to when the plurality of future transactions are to be executed.

16. The method of claim 15, wherein the method further comprises transmitting the plurality of future transactions or disbursements to the user at the plurality of different times based on expirations of the plurality of TTL jobs, respectively.

17. A non-transitory computer-readable medium comprising instructions which when executed by a computer cause a processor to perform a method comprising:
storing a first plurality of transaction records and a second plurality of transaction records which are associated with a user
receiving a request to verify an eligibility of the user;
executing a machine learning model on the first plurality of transaction records to identify missing values of the plurality of transaction records and adding the missing values to the plurality of transaction records;
determining whether the user is eligible based on a comparison of the second plurality of transaction records to the first plurality of transaction records with the missing values added; and
writing results of the determination to a data store.

18. The non-transitory computer-readable medium of claim 17, wherein the receiving comprises receiving a blockchain transaction with a request to verify the eligibility of the user via a blockchain-enabled peer of the host platform, and in response, executing a blockchain smart contract via the blockchain-enabled peer to read the first and second plurality of transaction records from a distributed blockchain ledger, and executing the blockchain smart contract to write the results of the determination to the distributed blockchain ledger.

19. The non-transitory computer-readable medium of claim 17, wherein the method further comprises:
obtaining a plurality of data records storing data of the user;
extracting a value of a target data point from each data record in the plurality of data records to obtain a plurality of extracted values of the user for the target data point, respectively; and
determining a consistency of the value of the user for the target data point across the plurality of extracted values of the target data point.

20. The non-transitory computer-readable medium of claim 17, wherein the method further comprises executing a second machine learning model on the first plurality of transaction records and the second plurality of transaction records and identifying one or more matching electronic transactions included in both the first and second plurality of transaction records based on the executing,
wherein the determining further comprises determining whether the user is eligible based on the one or more identified matching electronic transactions included in both the first and second plurality of transaction records.
